(19) United States
(12) Patent Application Publication
(10) Pub. No.: US 2012/0179676 A1
(43) Pub. Date: Jul. 12, 2012

(54) METHOD AND APPARATUS FOR ANNOTATING IMAGE IN DIGITAL CAMERA

(75) Inventor: Tae-suh PARK, Yongin-si (KR)

(73) Assignee: SAMSUNG ELECTRONICS CO., LTD., Suwon-si (KR)

(21) Appl. No.: 13/183,624

(22) Filed: Jul. 15, 2011

(30) Foreign Application Priority Data
Jan. 7, 2011 (KR) 10-2011-0001797

(51) Int. Cl. G06F 17/30

(52) U.S. Cl. 707/736; 707/E17.014

(57) ABSTRACT

A method and apparatus for annotating an image of a digital camera are disclosed. The method includes taking a photograph, transmitting a message including an image and an identifier of the photograph to a mobile terminal, receiving a response message including metadata and the identifier, determining an image file to be updated by using the identifier, and updating at least one metadata area of the image file with the metadata of the response message. The apparatus includes a message transmitting/receiving unit which transmits to a mobile device a message including an image and an identifier, and receiving a response message from the mobile terminal including metadata and the identifier. An annotation unit determines an image file to be updated based on the response message received from the message transmitting/ receiving unit by using the identifier.

### CROSS-REFERENCE TO RELATED PATENT APPLICATION

This application claims the benefit of Korean Patent Application No. 10-2011-0001797, filed on Jan. 7, 2011, in the Korean Intellectual Property Office, the disclosure of which is incorporated herein in its entirety by reference.

### BACKGROUND

1. Field

The present inventive concept relates to a digital camera. More particularly, the inventive concept relates to a method and apparatus for annotating an image of a digital camera. The digital camera may easily create and store a comment regarding a photograph taken by the digital camera.

2. Description of the Related Art

In general, a digital camera, unlike an analog camera, may not need to use film, may easily take a photograph at any time, and may easily delete a photograph as needed.

Meanwhile, in order to provide a comment or an impression of a specific photograph, a field for a comment is defined in metadata of a photograph storage format, of the digital camera.

However, since characters are input on a touch screen without an appropriate character input unit due to form factor restrictions of the digital camera, it is rare for a user to provide annotations. Also, it is quite difficult to add a comment right after each photograph is taken. Even though the user is able to add a comment right after taking each photograph, this may be cumbersome and may interrupt the taking of photographs.

Accordingly, most users delay making annotations until the photograph data is backed up on a personal computer (PC). However, if a long time elapses after a photograph is taken, it may be difficult for a user to feel the same inspiration as he/she felt while taking the photograph. In addition, it is difficult to back up hundreds of photographs to a PC and then make annotations to the photographs.

### SUMMARY

The present inventive concept provides a method and apparatus for annotating an image of a digital camera, in which a user may use a mobile phone to easily add a comment to a photograph.

According to an aspect of the present inventive concept, there is provided a method of annotating an image of a digital camera, the method including: upon taking a photograph, transmitting to a mobile terminal a message including both an image of the photograph and an identifier; receiving from the mobile terminal a response message which includes both metadata and the identifier corresponding to the image; determining an image file to be updated by using the identifier of the response message and updating at least one metadata area of the determined image file with the metadata of the response message.

When the photograph is taken, the method may further include generating an identifier for an image of the photograph.

The identifier may be an image file name that is automatically generated when the photograph is taken. The identifier may be a hash value of an image file or a visual signature.

The identifier for the image may be clearly written to the response message as a character string in either a text field or a title field.

The metadata may include a comment and a preference score.

If one or more of the response messages exists, the metadata may be updated in an accumulative manner.

The determining of the image file to be updated may include extracting the metadata and the identifier from the response message, and determining an image file matching the extracted identifier as an image file to be updated.

The determining of the image file to be updated may include: checking a character string of either a text field or a title field of the response message in order to determine whether an image file exists having a name which matches a unique file name in the character string; and if the image file exists, determining the image file to be a corresponding image.

The determining of the image file to be updated may include: searching a hash database or a visual signature database of images which are previously stored in order to obtain a hash value or a visual signature of each of the images in a list, and comparing the hash value or the visual signature with a hash value or a visual signature which corresponds to the identifier in order to determine whether an image file which matches the identifier; and if the image file exists, determining the image file to be a corresponding image.

The message transmitted to the mobile terminal may be a multimedia message service (MMS) message.

The message transmitted to the mobile terminal may be an MMS message or a short message service (SMS) message.

The message transmitted to the mobile terminal and the response message may be transmitted to and received from the mobile terminal through a messaging server.

The messaging server may enable a message to be exchanged between a mobile terminal in which a modem is installed and an Internet access device in which a modem is not installed.

The mobile terminal may generate metadata corresponding to the image and may generate a response message including both the metadata and the identifier.

According to another aspect of the present inventive concept, there is provided an apparatus for annotating an image of a digital camera, the apparatus including: a message transmitting/receiving unit which transmits a message including an image and an identifier to a mobile terminal and receives a response message including metadata and the identifier which corresponds to the image from the mobile terminal; and an annotation unit which determines an image file to be updated by the response message received from the message transmitting/receiving unit by using the identifier, and updates at least one metadata area of the image file with the metadata of the response message.

The annotation unit may extract the metadata and the identifier from the response message, and acquire an image file which corresponds to the extracted identifier.

### BRIEF DESCRIPTION OF THE DRAWINGS

The above and other features and advantages of exemplary embodiments of the inventive concept will become more apparent by describing in detail exemplary embodiments thereof with reference to the attached drawings in which:

FIG. 1 is a conceptual view for explaining image annotation according to an exemplary embodiment;

FIG. 2 is a block diagram of an image annotation system according to an exemplary embodiment;

FIG. 3A is a block diagram of a digital camera according to an exemplary embodiment;

FIG. 3B is a block diagram of a control unit of FIG. 3A, according to an exemplary embodiment;

FIG. 4 is a flowchart illustrating a method of annotating an image in the image annotation system of FIG. 2, according to an exemplary embodiment;

FIG. 5 illustrates a Joint Photographic Experts Group (JPEG) format of the digital camera in which metadata of FIG. 4 is to be stored; and

FIG. 6 is a flowchart illustrating a method of annotating an image of a digital camera, according to an exemplary embodiment.

### DETAILED DESCRIPTION

The present inventive concept will now be described more fully with reference to the accompanying drawings, in which exemplary embodiments are shown.

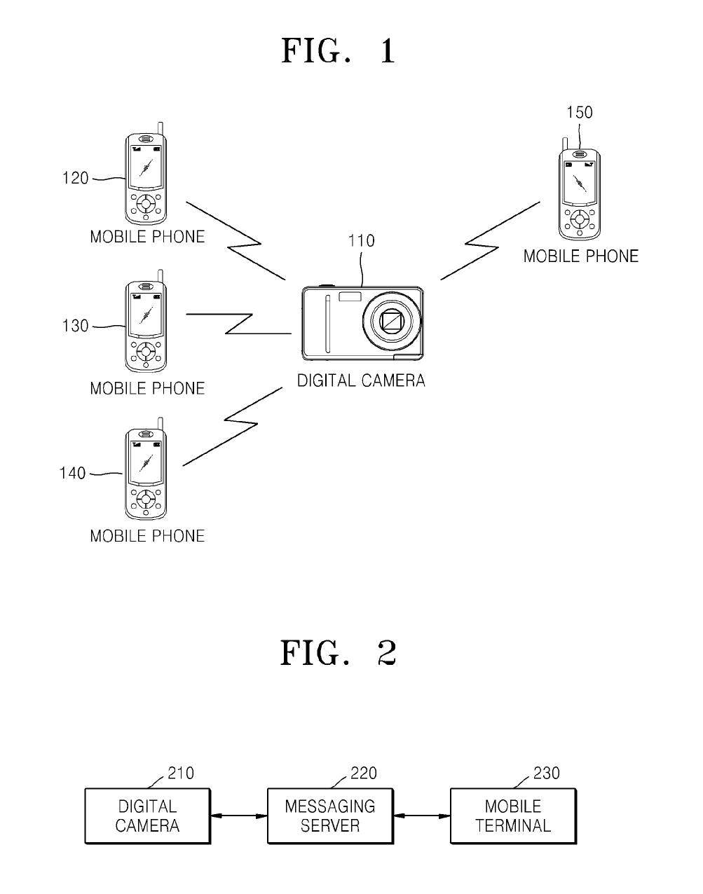

FIG. 1 is a conceptual view for explaining image annotation according to an exemplary embodiment.

Image annotation occurs when an “add a comment” function and/or an “assign a score” function are performed.

Referring to FIG. 1, after taking a specific photograph, a digital camera 110 transmits a multimedia message service (MMS) message including an image of the photograph to mobile phones 120 through 150.

Mobile phones 120 through 150 add comments or assign scores to the specific photograph and transmit short message service (SMS) or MMS messages as responses to digital camera 110.

Digital camera 110 collects the comments or scores received from mobile phones 120 through 150, and stores the comments or scores in a metadata area of the photograph.

As a result, the specific photograph taken by digital camera 110 may be effectively annotated through a message exchange between digital camera 110 and mobile phones 120 through 150.

FIG. 2 is a block diagram of an image annotation system according to an exemplary embodiment.

The image annotation system of FIG. 2 includes a digital camera 210, a messaging server 220, and a mobile terminal 230. Digital camera 210, messaging server 220, and mobile terminal 230 exchange messages through Wi-Fi or 2.5G/3G/4G networks.

Digital camera 210 has a Wi-Fi modem or a 2.5G/3G/4G modem installed therein. Digital camera 210 transmits an MMS message including an image captured by digital camera 210 and an identifier to mobile terminal 230 through the messaging server 220. Digital camera 210 receives a response MMS or SMS message including a comment or a score and the identifier which corresponds to the image through the messaging server 220 from mobile terminal 230, determines an image file to be updated by using the identifier, and updates at least one metadata area of the image file with the comment of the response MMS or SMS message.

Messaging server 220 is a mobile carrier or a mobile virtual network operator (MVNO) service server, and transmits and receives an MMS message introduced from Wi-Fi or a cellular network to and from mobile terminal 230. Messaging server 220 enables a message to be exchanged between a mobile terminal in which a modem is installed and an Internet access device in which a modem is not installed.

Mobile terminal 230 has a general MMS or SMS function, receives an MMS message including an image and an identifier from digital camera 210, adds a comment or assigns a score to the image, and transmits a response MMS message, including the comment or the score and the identifier for the image, to digital camera 210 through messaging server 220.

Mobile terminal 230 may be, for example, a mobile phone or a smartphone, but the exemplary embodiment is not limited thereto.

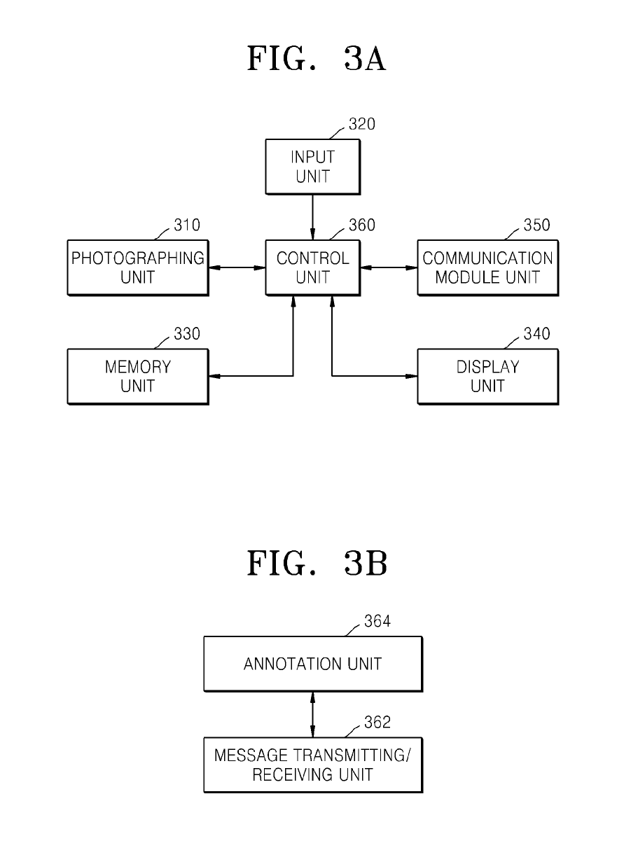

FIG. 3A represents a block diagram of digital camera 210 according to an exemplary embodiment.

Referring to FIG. 3A, digital camera 210 includes a photographing unit 310, an input unit 320, a memory unit 330, a display unit 340, a communication module unit 350, and a control unit 360.

Photographing unit 310 captures an image of a subject, and converts light of the image of the subject falling on a light-receiving surface, into a digital image by using predetermined signal processing.

Input unit 320 permits a user to input manipulation command for image annotation by pressing one or more of a plurality of buttons. Input unit 320 may be, for example, a manipulation input device such as a keyboard or a mouse, buttons, direction keys, or a combination thereof, but the exemplary embodiment is not limited thereto.

Control unit 360 includes, for example, a micro processing unit (MPU) or an integrated circuit where a plurality of circuits for performing a control function are integrated. Control unit 360 outputs an image captured by photographing unit 310 and a manipulation command input from input unit 320 to display unit 340, and makes annotations according to the manipulation command, for image annotation received from input unit 320.

That is, control unit 360 outputs a message including an image captured by photographing unit 310 and an identifier, through communication module unit 350, and stores metadata and the identifier in a response message input through communication module unit 350 in memory unit 330. Control unit 360 determines an image file to be updated by using the identifier, and updates a metadata area of the image file by using metadata found in the response message.

Memory unit 330 stores data for annotation processed by control unit 360, or stores data necessary for operating control unit 360. Memory unit 330 may be a magnetic recording medium such as a hard disk, or a non-volatile memory such as an electrically erasable programmable read-only memory (EEPROM) or a flash memory, but the present exemplary embodiment is not limited thereto.

Display unit 340 displays an image output through control unit 360 and a manipulation command input from input unit 320.

Display unit 340 may be a liquid crystal display (LCD), but the present exemplary embodiment is not limited thereto.

Communication module unit 350 has a Wi-Fi modem or a 2.5G/3G/4G modem installed thereon, converts an MMS message output from control unit 260 into a communication format, and communicates with mobile terminal 230 through Wi-Fi or 2.5G/3G/4G networks.

FIG. 3B is a block diagram of the control unit 360 of FIG. 3A, according to an exemplary embodiment.

Referring to FIG. 3B, control unit 360 includes a message transmitting/receiving unit 362 and an annotation unit 364.

First, message transmitting/receiving unit 362 transmits a message including an image, which is captured along with an identifier, to the mobile terminal 230, and receives a response message including metadata and the identifier which corresponds to the image from mobile terminal 230.

Annotation unit 364 determines an image file to be updated based on the response message received from message transmitting/receiving unit 362, by using the identifier, and updates at least one metadata area of the image file with metadata from the response message.

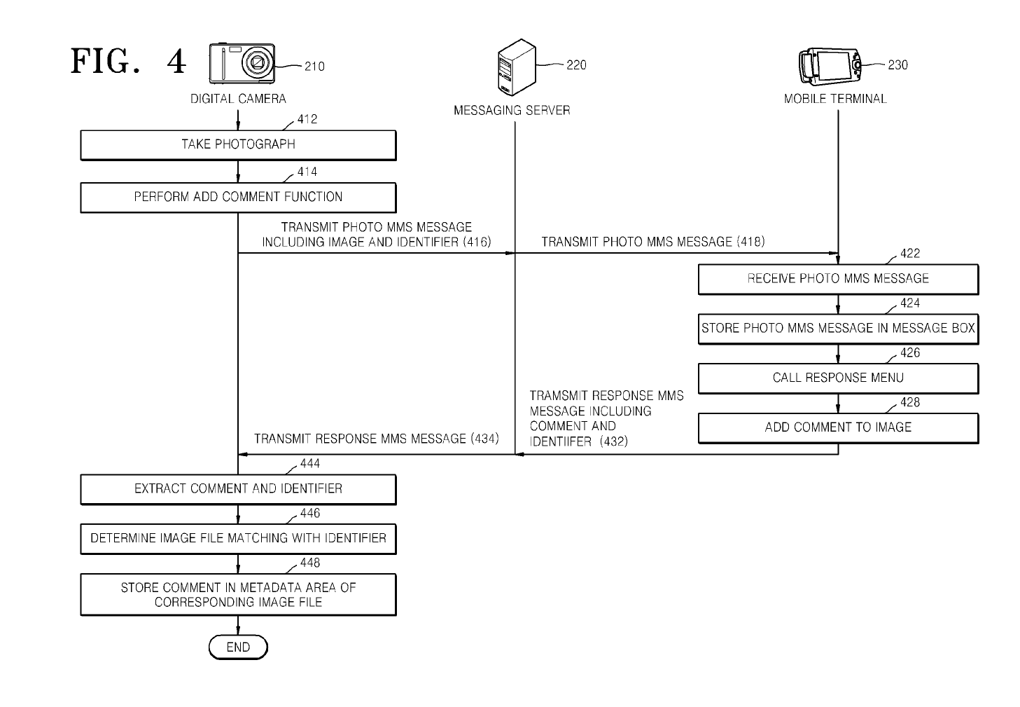

FIG. 4 is a flowchart illustrating a method of annotating an image in the image annotation system of FIG. 2, according to an exemplary embodiment.

First, in operation 412, digital camera 210 stores an image captured by taking a photograph. In this situation, digital camera 210 automatically generates an identifier which corresponds to the image captured by taking the photograph.

Next, in operation 414, digital camera 210 calls up a menu and performs an “add a comment” function.

In operation 416, at least one photo MMS message including the identifier and a resized version of image of the photograph are transmitted to messaging server 220 by using a telephone number that is previously stored or input. The resized version may be a screen view file stored at the same time as the photograph is taken in order to be output to an LCD in digital camera 210. Also, the telephone number refers to a mobile phone of a user of digital camera 210, but may be a mobile phone number of another person.

Also, the identifier may be a unique file name (e.g., IMG002142.jpg), a hash value of an image file, or a visual signature used in fingerprint technology, but the present exemplary embodiment is not limited thereto.

Digital camera 210 may set the unique file name, attached as the identifier as a first character string of a text field or a title field of the photo MMS message to be transmitted.

Alternatively, digital camera 210 may include the hash value or the visual signature of the image file as the identifier in the photo MMS message.

In operation 418, messaging server 220 transmits the photo MMS message to mobile terminal 230.

In operation 422, mobile terminal 230 receives the photo MMS message, including the identifier, and the image from messaging server 220.

In operation 424, mobile terminal 230 stores the photo MMS message received from messaging server 220 in a message box.

In operation 426, mobile terminal 230 calls a response menu.

In operation 428, mobile terminal 230 adds a comment to the image.

In operation 432, when the comment is completely added to the image, mobile terminal 230 transmits a response MMS message including the comment and the identifier to messaging server 220. In this situation, if a plurality of MMS messages exist, since an image transmission order and a response order may not match with each other according to MMS asynchronous transmission characteristics or the user's behavior, the identifier included in the photo MMS message received from messaging server 220 is re-used in the first character string of the text field or the title field of the response MMS message.

Since the unique file name of the photo MMS message received from messaging server 220 is re-used as the first character string of the text field or the title field of the response MMS message, the response MMS message clearly specifies that “the current message includes the comment for the photograph IMG002142.jpg”.

Alternatively, the visual signature or the hash value of the image file may be included as the identifier in the response MMS message.

In this situation, the response MMS message may be composed by using a “reply” function or a “forward” function in a common MMS client or by using a separate application in a smartphone.

In operation 444, digital camera 210 receives the response MMS message and extracts the identifier and the comment from the response MMS message. The identifier may be the unique file name, the hash value of the image file, or the image visual signature, but the present embodiment is not limited thereto.

In operation 446, digital camera 210 determines an image file which matches the extracted identifier. For example, digital camera 210 may check the first character string of the text field or the title field of the response MMS message to determine whether an image file exists having a name matching the unique file name that is the identifier in the corresponding character string. If the image file exists, digital camera 210 determines the matched image file to be a corresponding image.

Alternatively, if the identifier is the hash value or the visual signature, digital camera 210 searches a hash database or a visual signature database of images which are previously stored in order to obtain a hash value or a visual signature for each image in a list. Digital camera 210 compares the hash value or the visual signature with a hash value or a visual signature corresponding to the identifier in order to determine whether an image file exists which matches the identifier. If the image file exists, digital camera 210 determines the image file to be a corresponding image file.

In operation 448, digital camera 210 stores the comment in a metadata area of the corresponding image file.

For example, if the corresponding image file exists, digital camera 210 stores the comment in a “UserComment” field in an “exchangeable image file format image file directory (EXIF IFD)” or an “ImageDescription” field in a “tag image file format image file directory (TIFF IFD)” field from among metadata fields of the corresponding image file.

As a result, the photograph taken by digital camera 210 may be effectively annotated through message exchange between mobile terminal 230 and digital camera 210.

An “assign a score” function which may also be performed for image annotation will now be explained.

In order to perform an “assign a score” function, digital camera 210 collects and stores a plurality of comments for one image. In this situation, the plurality of comments are stored in a metadata field, for example, a “Maker Note” field, other than a metadata field for an “add a comment” function.

A process of collecting and storing the plurality of comments will now be explained.

If a message is transmitted to three friends by using an “assign a score” function and all of the three friends respond, messages transmitted from the three friends are collected by the digital camera 210 in a random order in order to obtain an average score. For example, if the three friends transmit messages respectively corresponding to 3, 5, and 5 points, a first score and the number of received messages are stored as “3-1” in a specific field of an “exchangeable image file format (EXIF)” field. If a message corresponding to a second score is received, the specific field of the “EXIF” field is updated to “4-2” as a result of “(3*1+5)/2=4”, and if a message corresponding to a last score is received, the specific field of the “EXIF” field is updated to “4.4-3” as a result of “(4*2+5)/3=4.3)”.

As a result, digital camera 210 updates scores received from a plurality of mobile terminals in an accumulative manner and stores the received scores in a metadata area.

The scores are updated and stored in the metadata area in the accumulative manner may be expressed as Equation 1.

m′=(m×n+c)/n+1 [Equation 1]

where m′ is an updated score, m is a score previously calculated and stored from (n−1) messages, n is the number of received messages, and c is a received score.

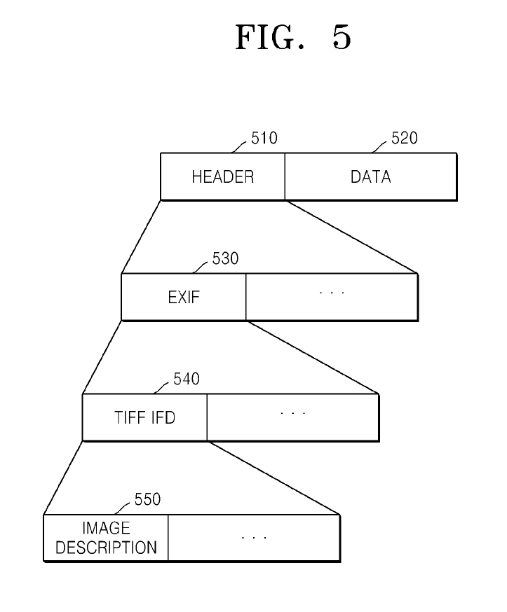

FIG. 5 illustrates a Joint Photographic Experts Group (JPEG) format of digital camera 210 in which metadata of FIG. 4 is to be stored.

The JPEG format of digital camera 210 is divided into a header field 510 and a data field 520. Header field 510 includes an EXIF field 530 and other fields. EXIF field 530 includes a TIFF IFD field 540 and other fields. TIFF IFD field 540 includes an ImageDescription field 550 and other fields. Metadata such as a comment or a score may be stored in ImageDescription field 550.

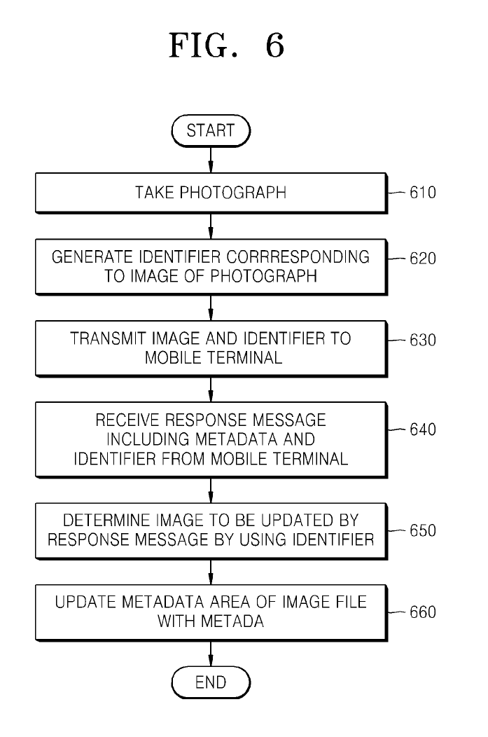

FIG. 6 is a flowchart illustrating a method of annotating an image of a digital camera, according to an exemplary embodiment.

In operation 610, a photograph is taken. In operation 620, an identifier corresponding to an image of the photograph is generated.

In operation 630, an MMS message including the image and the identifier by calling a menu is composed, and then is transmitted to the mobile terminal 230 by using a telephone number that has been previously stored or has been input. The identifier may be an image file name which is automatically generated during taking the photograph or a hash value of an image file or a visual signature. Also, the telephone number may be a mobile phone number of a user of the digital camera or a mobile phone number of another person.

In operation 640, a response MMS or SMS message including the identifier and metadata corresponding to the image, is received from mobile terminal 230. The metadata includes a comment or a preference score.

In operation 650, the metadata and the identifier are extracted from the response MMS or SMS message, and an update of the image file is determined by using the identifier.

In operation 660, at least one metadata area of the determined image file is updated with the metadata. If there exist one or more response messages for the metadata area to be updated, metadata of the metadata area is updated in an accumulative manner.

Accordingly, the present inventive concept may effectively annotate a photograph of a digital camera by using a familiar character input unit of a mobile phone and the performance of a character message service.

The present invention may be embodied as computer-readable codes in a non-transitory computer-readable recording medium. The computer-readable recording medium may be any recording apparatus capable of storing data in a data structure that is read by a computer system. Examples of the computer-readable recording medium include read-only memories (ROMs), random-access memories (RAMs), CD-ROMs, magnetic tapes, floppy disks, and optical data storage devices. The computer-readable recording medium may be a carrier wave that transmits data via the Internet, for example. The computer readable medium may be distributed among computer systems that are interconnected through a network, and the present inventive concept may be stored and implemented as computer readable codes in the distributed system.

While the present invention has been particularly shown and described with reference to exemplary embodiments thereof using specific terms, the exemplary embodiments and terms have been used to explain the present invention and should not be construed as limiting the scope of the present invention, which is defined by the claims. Accordingly, it will be understood by those of ordinary skill in the art that various changes in form and details may be made therein without departing from the spirit and scope of the present invention as defined by the following claims.

What is claimed is:

1. A method of annotating an image of a digital camera, the method comprising:
after a photograph is taken, transmitting a message including an image of the photograph and an identifier, to a mobile terminal;
receiving a response message including metadata and the identifier corresponding to the image, from the mobile terminal;
determining an image file to be updated by using the identifier of the response message; and
updating at least one metadata area of the determined image file with the metadata of the response message.

2. The method of claim 1, further comprising:
when the photograph is taken, generating an identifier of an image of the photograph.

3. The method of claim 1, wherein the identifier is an image file name that is automatically generated when the photograph is taken.

4. The method of claim 1, wherein the identifier is a hash value of an image file or a visual signature.

5. The method of claim 1, wherein the identifier of the image is clearly written to a character string of a text field or written to a title field of the response message.

6. The method of claim 1, wherein the metadata comprises a comment and a preference score.

7. The method of claim 1, wherein, in the response to the existence of one or more of the response messages, updating the metadata in an accumulative manner.

8. The method of claim 1, further comprising:
the determining of the image file to be updated includes extracting the metadata and the identifier from the response message, and determining an image file which matches the extracted identifier as an image file to be updated.

9. The method of claim 8, further comprising:
the determining of the image file to be updated includes checking a character string of a text field or a title field of the response message in order to determine whether an image file exists which has a name matching a unique file name in the character string; and
in response to the existence of the image file, determining the image file as a corresponding image.

10. The method of claim 8, further comprising:
the determining of the image file to be updated includes searching a hash database or a visual signature database of images which are previously stored to obtain a hash value or a visual signature of each of images in a list, and comparing the hash value or the visual signature with a hash value or a visual signature corresponding to the identifier in order to determine whether an image file exists which matches the identifier; and
in response to a determination that the image file exists, determining the image file to be a corresponding image.

11. The method of claim 1, wherein the message transmitted to the mobile terminal is a multimedia message service (MMS) message.

12. The method of claim 1, wherein the message transmitted to the mobile terminal is an MMS message or a short message service (SMS) message.

13. The method of claim 1, wherein both the message transmitted to the mobile terminal and the response message are transmitted to and received from the mobile terminal through a messaging server.

14. The method of claim 13, wherein the messaging server enables a message to be exchanged between a mobile terminal in which a modem is installed and an Internet access device in which a modem is not installed.

15. The method of claim 1, wherein the mobile terminal generates metadata corresponding to the image and generates a response message including the metadata and the identifier.

16. An apparatus for annotating an image of a digital camera, the apparatus comprising:
a message transmitting/receiving unit which transmits a message including an image and an identifier corresponding to the image to a mobile terminal and receives a response message comprising metadata and the identifier corresponding to the image from the mobile terminal; and
an annotation unit which determines an image file to be updated by the response message received from the message transmitting/receiving unit by using the identifier, and updates at least one metadata area of the image file with the metadata of the response message.

17. The apparatus of claim 16, wherein the annotation unit extracts the metadata and the identifier from the response message, and acquires an image file which corresponds to the extracted identifier.

18. A non-transitory computer-readable recording medium having embodied therein a program, wherein the program, when operated on by a processor of a computer, causes the computer to execute the method of claim 1.

19. A method of annotating an image of a digital camera, the method comprising:
transmitting to a mobile terminal, a message including an image of a photograph taken with a digital camera and an identifier;
receiving from the mobile terminal a response including metadata and the identifier corresponding to the image;
using the identifier of the response message to determine an image file to be updated; and
updating at least one metadata area of the determined image file with the metadata of the response message.

20. An apparatus for annotating an image of a digital camera, the apparatus comprising:
a message transmitting/receiving unit which transmits to a mobile device a message including an image and an identifier which corresponds to the image, and receives a response message from the mobile terminal including metadata and the identifier corresponding to the image; and
an annotation unit which determines an image file to be updated based on the response message received from the message transmitting/ receiving unit by using the identifier, the annotation unit updates at least one metadata area of the image file with the metadata of the response message.
